(19) United States
(12) Patent Application Publication
(10) Pub. No.: US 2022/0067825 A1
(43) Pub. Date: Mar. 3, 2022

(54) SYSTEMS AND METHODS FOR CREATING DYNAMIC CREDIT LIMIT AND RECOURSE BASE FOR SUPPLY CHAIN FINANCE

(71) Applicant: IFG Network LLC trading as The Interface Financial Group, Bethesda, MD (US)

(72) Inventor: George SHAPIRO, Bethesda, MD (US)

(21) Appl. No.: 17/006,225

(22) Filed: Aug. 28, 2020

(51) Int. Cl. G06Q 40/02; G06Q 30/04; G06Q 40/00; G06Q 30/00; G06Q 50/26; G06Q 50/00; G06N 20/00; G06F 9/54

(52) U.S. Cl. CPC G06Q 40/025; G06Q 30/04; G06Q 40/12; G06F 9/547; G06Q 50/265; G06Q 50/01; G06N 20/00; G06Q 30/0185

(57) ABSTRACT

Systems and methods of dynamically creating credit limits and automatically mitigating risk in real time provide digital supply chain finance services for buyer-supplier pairs based on sets of related fast data and other event driven applications. Suppliers who sell goods and services to other businesses (buyers) use the systems and methods of the invention to request payment up to the dynamic credit limit from a third-party supply chain financial provider. Dynamic credit limits are calculated automatically based on digital analysis of data sets automatically pulled from multiple sources. Suppliers request payment against an approved and scheduled payment invoice by a buyer (“confirmed invoices”) earlier than the scheduled payment date (“early payment”). Supply chain finance providers offer a fully digital early payment solution against confirmed invoices where risks of non-payment or receipt of diluted payments for funded invoices are mitigated by a structured recourse base that is automatically created by establishing the dynamic credit limit.

### TECHNICAL FIELD

This technology relates to systems and methods for supply chain finance. More particularly, the technology relates to systems and methods for analyzing credit risks and risk of invoice payment dilutions for business organizations, determining a dynamic credit limit and a recourse base in real time, and providing early payment services and solutions against confirmed invoices based on the dynamic credit limit.

### BACKGROUND

Supply chain finance (SCF) includes technology-based solutions to lower financing costs and improve business efficiency for buyers and sellers linked in a sales transaction. Supply chain finance methodologies work by automating transactions and tracking invoice approval and settlement processes from initiation to completion. Buyers agree to approve their suppliers' invoices for financing by a bank or other outside financier. By providing short-term credit that optimizes working capital and provides liquidity to both parties, supply chain finance offers advantages to all participants. Suppliers gain quicker access to money they are owed, and buyers get more time to pay off their balances. Both parties can use the cash on hand for other projects to keep their respective operations running. smoothly.

Supply chain finance includes “supplier finance,” “payables finance,” and “reverse factoring,” and encourages collaboration between buyers and sellers. This philosophically counters the competitive dynamic that typically arises between a buyer and seller. Under usual circumstances, buyers attempt to delay payment, while sellers look to be paid as soon as possible.

Supply chain finance can optimize cash flows and working capital by allowing buyers to lengthen their payment terms to their suppliers while providing the option for their suppliers to get paid early. Supply chain finance is often used when the buyer has a better credit rating than the seller and can consequently source capital from a bank or other financial provider at a lower cost. This advantage lets buyers negotiate better terms from the seller, such as extended payment schedules. Meanwhile, the seller can unload its products more quickly, to receive immediate payment from the bank or other intermediary financing body.

A traditional supply chain finance situation involves extending payment terms. An extended payables transaction might include a buyer (company) that purchases goods from a seller (supplier). Traditionally, supplier ships the goods, then submits an invoice to company, which approves the payment on standard credit terms of 30 days, for example. But if supplier is in urgent need of cash, supplier may request immediate payment, at a discount, from the company's affiliated financial institution, such as a bank. The bank or supply chain finance company intermediates the accounts receivable process for the buyer. When the immediate payment request is granted, that bank or financial institution issues payment to supplier, and in turn, charges the company a fee and extends the payment period for company for an additional further 30 days, for example, for a total credit term of 60 days, rather than the 30 days mandated by supplier.

However, supply chain financing is limited to companies that can be credit insured or is made available only to investment grade or near-investment grade suppliers. If the buyer cannot be credit insured or is sub-investment grade, the bank or some supply chain finance companies will not offer this solution.

In addition, supply chain finance providers, such as banks and other financial institutions throughout the world, are currently mitigating buyers' non-payment risks and payment dilution risks of invoices payable to suppliers by requesting and obtaining buyers' guarantees of payment for invoices which have been paid early. This current approach of addressing risks related to providing supply chain finance service creates several problems. For example, the guarantee of payment limits buyers' abilities to apply legitimate chargebacks, set-offs, counterclaims, and withholdings to the invoice payments payable to suppliers.

Another problem that buyers are facing by providing a guarantee is an increasing requirement for the modification and de-recognition of the buyers' trade payables and reclassification of trade payables as a debt on the buyers' balance sheets. Such requirements can create significant accounting treatment issues for buyers when classifying both liabilities to a trade creditor and liabilities to a financial institution as debt.

These technological problems create limitations to the buyers' ability to initiate and offer supply chain finance service for their suppliers. Several attempts to create technical solutions that allow waivers of the buyers' guarantee requirements for supply chain finance services have been unsuccessful and unreliable.

### SUMMARY

The systems and methods of the invention provide technical solutions to the dearth of current supply chain finance methods and systems. The invention is based on a dynamic credit limit that reliably allows banks and other financial institutions to offer supply chain finance service without requesting a payment guarantee from a buyer, which is traditionally used as a hedge against the risks of non-payment and payment dilution.

Systems and methods of the invention determine a dynamic credit limit and a recourse base in real time, and provide early payment services and solutions against confirmed invoices based on the dynamic credit limit. The dynamic credit limit systems and methods described in this disclosure provide a technological solution to an issue rooted in technology, including improved systems and methods for processing and analyzing disparate data in large volumes at scale from multiple sources.

The invention provides methods and systems for real time calculation of a dynamic credit limit and related recourse base for a Supplier-Buyer pair, allowing supply chain finance providers to make early payments to Suppliers without asking Buyers for a payment guarantee while simultaneously reliably mitigating Buyer's non-payment and payment dilutions risks. Specifically, the systems and methods of the invention allows analysis, in real time, of historical payment dilutions between a specific Buyer and Supplier and issuance of the credit/risk score, also in real time, based on the analysis of a variety of data, instantly pulled from thousands of data points in data-feed formats, related to fraud/threat, credit history, liens/taxes/judgments, compliance, and other information that can be used to predict payment dilution and necessary recourse base for the buyer-supplier pair.

The dynamic credit limit (supply chain finance provider) server may unconventionally utilize data from a variety of third party platforms, including e-invoicing platforms, accounting systems, buyer ERP systems, fraud/threat data sources, credit bureaus, compliance data sources, liens searches sources, social value sources and other platforms from which large data sets may be analyzed computationally to reveal patterns, trends, and associations that provide an analytical information-based platform for determining a dynamic credit limit in real time. For example, the dynamic credit limit server may analyze rich data from third party platforms, including data on suppliers and buyers (e.g., a customer of a supplier), and the dynamic credit limit server can generate on-the-fly determinations of payments for invoices chosen by the supplier, less a discount

The dynamic credit limit server analyzes the data and provides a dynamic credit limit that allows supply chain finance service without buyer payment guarantee. By seamlessly integrating the dynamic credit limit server with buyer ERP systems and supplier accounting software (e.g., QuickBooks®, Xero, FreshBooks, Sage, NetSuite, etc.), supply chain finance providers can accurately provide a dynamic credit limit. Similarly, the invention extends its use of fast data from third party platforms into the dynamic credit limit calculus and can forgo a Buyer payment guaranty to mitigate non-payment and payment dilution risks. In this fashion the invention creates significant improvements in widening supply chain finance services worldwide. For suppliers, the benefits include a reduction of trade receivables and an increase in cash position, faster access to cash at advantageous rates, and stronger ties and cooperation with the buying company, which can create competitive advantages. Additionally, suppliers benefit from a faster cash conversion cycle from delivery to cash, working capital optimization, and improved liquidity. Benefits for buyers include maximized use of e-invoicing, self-billing, and cooperation with suppliers.

Users (suppliers) choose a payment date for invoices that theft customer (buyer) has approved and scheduled for payment in exchange for paying a small discount to the invoice value to the supply chain finance provider. The invention allows suppliers to view invoices approved and scheduled for payment by their customer (buyer) and to choose invoices for early payment. As users (suppliers) choose invoices, the systems and methods of the invention continually calculate and update the dynamic credit limit. Suppliers can take early payment on as many invoices as desired, up to the limit of the dynamic credit limit. The systems and methods of the invention simultaneously calculate and update a recourse base as well.

One example of how the dynamic credit limit determination can be used is when suppliers need a specific amount of money (e.g., for payroll, inventory, working capital, etc.), a cash planner feature enables a user to enter an amount of money needed and automatically identifies invoices for early payment that total to the amount of money entered by the supplier. This provides a powerful cash management took

An additional example of how the dynamic credit limit determination can be used is when suppliers would like the digital supply chain finance method to be performed automatically (for example, without reviewing a list of invoices for early payment), the supplier can select an “always pay me early” feature. This feature provides ongoing early payment of invoices approved and scheduled for payment by the buyer up to the amount of the dynamic credit limit.

This innovation is creating a universally accessible system by transforming the score-related information about the Buyer-Supplier pair in real time into a factual machine algorithm which can be easily used by any supply chain finance service providers.

Prior supply chain finance systems and methods are not designed with a 360-degree view of Buyer-Supplier data in real time, in combination with the pair's historical payment dilution data analysis, and thus, these prior systems are unable to offer a reliable risk mitigation solution. Those methods are also more prone to error because they are unable to automatically take into account the vast majority of risk factors that are critical in helping to determine a proper risk mitigation structure.

This invention provides systems and methods of automatically creating a dynamic credit limit at the point-of-funding decision based on an analysis of critical risk factors data obtained in real time. The systems and methods of the invention, in turn, automatically structure a recourse base, allowing supply chain finance providers to mitigate non-payment and dilution risks. These systems and methods allow supply chain finance funders to provide supply chain finance service reliably and safely without requiring a buyer's payment guarantee.

Systems and methods in accordance with the invention include a digital supply chain finance system for creating a dynamic credit limit. In one example embodiment, the system includes a dynamic credit limit server application, including instructions stored on a non-transitory computer-readable medium executed on the dynamic credit limit server. The dynamic credit limit server and server application are configured to receive a request for service from a supplier via a supplier portal. The server and application are further configured to automatically receive confirmed invoices from a buyer enterprise resource planning server, and to automatically receive fast data from a data source. Additionally, the servers and applications are configured to determine the dynamic credit limit based on a gross amount of confirmed invoices issued to the buyer from the seller, a base ceiling, a historic dilutions multiplier, and a risk score multiplier.

Some embodiments of the invention are instantiated in a cloud server environment, where the dynamic credit limit server is a virtual server running in a cloud computing environment accessed by the supply chain finance system via a data exchange network.

The fast data received can be real-time data received from an event-driven server application of the data source and can be received from the event driven server application via an application program interface (API). In some instances, the fast data includes actionable data received from sensors, actuators, and/or machine-to-machine data exchange sources.

Some examples of the invention include a digital supply chain finance system where the base ceiling includes an initial maximum percentage of the gross amount of confirmed invoices issued to the buyer that are available for funding by the supply chain finance provider. The base ceiling can be established per buyer by underwriters of the supply chain finance provider.

Systems and methods in accordance with the invention can establish scoring multipliers in a number of ways. For example, the historic dilutions multiplier can be based on historical dilution events from an enterprise resource planning server of the buyer and a dilution prediction for the buyer-supplier pair. Historical dilution events from the enterprise resource planning system of the buyer can include automatic analysis of the data of historic payment amounts for confirmed invoices and corresponding gross amounts for the same confirmed invoices issued by the supplier over a predetermined time period.

Additionally, in some systems and methods of the invention, the dilution prediction for the buyer-supplier pair is based on the use of a machine learning (ML) model trained by billings and correspondent payments from 1st tier buyers to their suppliers in different industries, different jurisdictions, and different economic cycles. Often, the billings and payment amounts used for the machine learning (ML) model are significant (on the order of $ trillions). The machine learning models can then be used to further process the fast data, including billings of suppliers and payments of buyers, to determine the dilution prediction. The dynamic credit limit server can include machine learning (ML) modules for receiving the dilution prediction generated by the models and to incorporate the information in determining the dynamic credit limit.

Systems and methods in accordance with the invention include dynamic credit limit servers and applications that determine the risk score multiplier in a number of ways. For example, the risk score multiplier can be based on one or more of a financial analysis score, a fraud-threat score, a compliance score, a business credit score, a filed liens score, a success-social value score, and a track record score.

In some example embodiments of the invention, a financial analysis score is based on one or more of a profit and loss statement, a balance sheet, an accounts receivable aging report, and an accounts payable aging report received from the supplier's accounting software. Financial analysis scores can also be based on a number of other factors, including an extrapolated income determination, an equity-income ratio, an assets-liability ratio, a monthly revenue ratio, a total accounts payable-accounts receivable comparison, a time-based accounts payable-accounts receivable comparison, a highest accounts receivable concentration, and/or a reporting period.

Example implementations of the invention can base a fraud-threat score on one or more of an email risk based on an email address age, an IP address confidence based on a historical IP address fraudulent use, and an IP address risk based on a location of an IP address and a supplier location. Other bases for a fraud-threat score can include a Proxy-VPN-TOR determination based on a direct or non-direct connection, an email free-corporate determination based on whether a user is using corporate email or free email, and a city confidence score based on a location of a city and proximity to the supplier's address. Similarly, a fraud-threat score can include considerations of a geolocation score based on a supplier's address and IP address, a location accuracy radius score based on a supplier business location and user IP address distance, and a location average income score based on a weighted average of income per person for a postal code associated with the IP address. Likewise, additional considerations for a fraud-threat score can include a postal confidence score based on a business account address or a credit card address and a user address, and an address-phone residential-business score based on a user connection location.

Systems and methods in accordance with the invention can determine a compliance score based on a number of factors, including one or more of an international watchlist score based on an Office of Foreign Assets Control sanctions list, an enhanced credit score based on a combination of data from one or more registered credit agencies (and augmented with utility records, electoral rolls, and drivers' license records), and a passport-driver license-ID validation score (digital identity intelligence). Further, a compliance score can also be based on an address validation score, and a utility score based on correlation of utility bills with a user address.

Some implementations of the invention include dynamic credit limit servers and application that determine a business credit score based one or more of an active registration-time in business score, a derogatoriness score, an insolvency history score, a collection-revenue ratio score, a tax liens-CCJ (county court judgment) history score, and a trade names score, where these scores are based on credit reports in data-feed format received from a credit bureau.

Example systems and methods in accordance with the invention determine a filed liens score based on at least one of a number of not-terminated filings (UCC/PPSR/Charges) score (i.e., Uniform Commercial Code, Personal Property Securities Register, etc.), a number of not-terminated filings (AR/Debtors) score, a not-terminated filings (Inventory) score, a not-terminated filings (PMSI) score, a not-terminated filings (All Assets) score, any or all of which can be based on collateral descriptions. An alternate payee score based on existence of an active payment assignment to a third party can also be used in determining a filed liens score.

In some embodiments of the invention, the dynamic credit limit servers and applications can determine a success-social value score based on one or more of a level of education score, a career score, a loyalty score (based on frequency and duration of job changes), a Social Activity score (based on user social involvement in charities, community activities, and/or military background), and a reputation score (based on collected data related to user-signer reputation).

In some implementations of the invention a loyalty score can include a level of continued effort to achieve a goal and a measure of jumping back and forth from project to project.

Systems and methods in accordance with the invention can determine a track record score, where the track record score is with the supply chain finance provider and is based on at least one of a longevity of account score, a defaults number to transactions number ratio, a ratio of post-confirmation dilution to gross amount of all confirmed invoices, a ratio of post-confirmation dilution to a total of an amount of automatic recourse available in the current payment period, an amount of automatic recourse available in the next payment period, and a total confirmed invoices score. In some implementations of the invention, a post-confirmation dilution can include at least one of the set of an amount of unrelated credit-memos applied on the same date as an invoice scheduled payment date, an amount of chargebacks, withholdings, counterclaims and an amount of set-offs.

Any or all of the scores making up the risk score multiplier can be statically or dynamically weighted, for example, based on received fast data and other information received by the dynamic credit limit server. The scores making up the risk score multiplier can be dynamically weighted using different multipliers applied to each score to differentiate contributions of each score to the overall risk score multiplier.

In addition, in some example systems and methods of the invention, risk score multipliers are also based on a number of other factors including one or more of an Authentication Result score, an ID Passed/Failed/Unknown score, a Total ID Verification score, an ID Barcode Verification score, and an ID Data Extraction Reliability Level score. These factors contributing to digital identity intelligence can be based on analysis of driver licenses or passports for a predetermined jurisdiction.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a diagram of a system for creating a dynamic credit limit and related automatic recourse base for providing supply chain finance services in accordance with the invention.

FIGS. 2A-2B are flow diagrams of a method for creating an initial dynamic credit limit and recourse base for providing supply chain finance services in accordance with the invention as well as for subsequent supply chain finance funding.

FIG. 3 is a flow diagram of an example dynamic credit limit determination in accordance with the invention and showing relationships between system components and scores.

FIG. 4 is an example user interface screen in accordance with the invention showing supplier interactions with a system for creating a dynamic credit limit and related automatic recourse base.

FIG. 5 is an example user interface screen showing supplier interactions with a system for creating a dynamic credit limit and related automatic recourse base using a Cash Planner feature.

FIG. 6 is an example user interface screen showing supplier interactions with a system for creating a dynamic credit limit and related automatic recourse base using an Always-Pay-Me-Early feature.

### DETAILED DESCRIPTION

The systems and methods of the invention provide technical solutions for processing and analyzing disparate data in large volumes at scale from multiple sources. In analyzing the multitude of financial data quickly, accurately, and efficiently, dynamic credit limits and recourse bases are established in real time for suppliers. Dynamic credit limits determined in accordance with the invention are responsive to changes in information, including financial information from the buyer and the seller along with many other types of fast data received and evaluated by the dynamic credit limit systems and methods. The determinations of the dynamic credit limits reliably allow banks and other financial institutions to offer supply chain finance (SCF) service without requesting a payment guaranty from a buyer, which is traditionally used as a hedge against the risks of non-payment and payment dilution. By forgoing a payment guaranty from a buyer, supply chain finance services are more widely available and provide improved liquidity and working capital without effecting changes to accounting treatment.

The dynamic credit limit enables early payment services and solutions against confirmed invoices. As the fast data to the supply chain finance provider change, the dynamic credit limit for the supplier may also change. Similarly, as the number and volume/amount of confirmed invoices changes, the dynamic credit limit available to that supplier may also change. The invention described in this disclosure provides a technological solution in improved systems and methods for receiving, managing, and evaluating extensive and distinct data sets from a wide array of sources. This invention includes systems and methods that automatically create a dynamic credit limit at the point-of-funding decision based on analysis of critical risk factors identified in the fast data obtained in real time. The systems and methods of the invention also automatically structure a recourse base, allowing supply chain finance providers to mitigate non-payment and dilution risks. These systems and methods allow supply chain finance funders to reliably and safely provide supply chain finance services without requiring a buyer payment guaranty.

System Overview

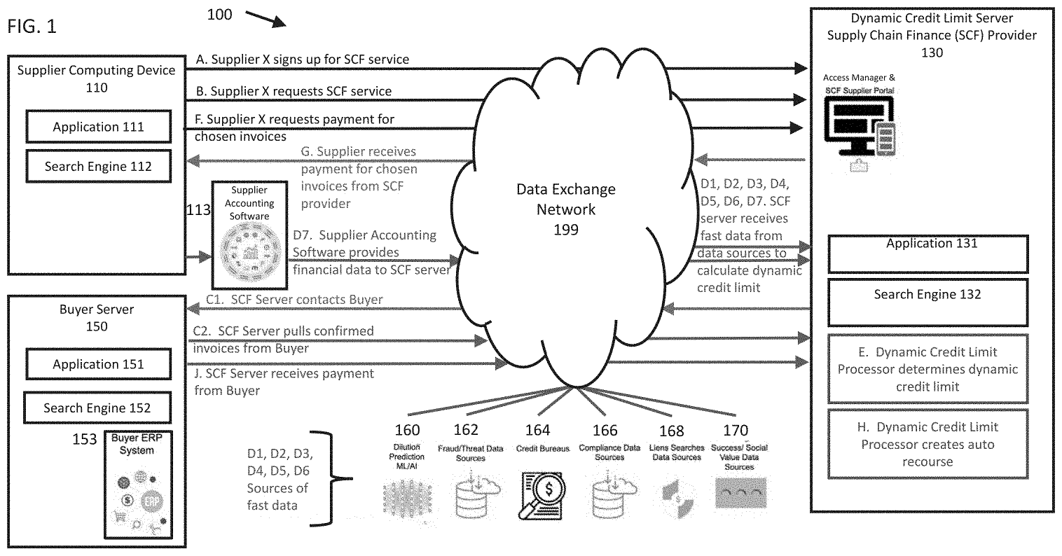

Example embodiments of the invention feature systems and methods for creating a dynamic credit limit. FIG. 1 shows a block diagram of a multimodality supply chain finance provider system 100 for receiving requests for supply chain finance services, automatically receiving confirmed invoices, automatically receiving fast data, and determining the dynamic credit limit. System 100 includes data exchange network 199. Data exchange network 199 is the medium used to provide communications links between various devices and computers connected together within the system 100. Data exchange network 199 can include connections, such as wire, wireless communication links, or fiber optic cables, from individual clients, servers, sources of fast data, and processing components. The clients, servers, data sources, and processing components can access the data exchange network 199 using different software architectural frameworks, different web services, different file transfer protocols, and different Internet exchange points. Data exchange network 199 can represent a collection of networks and gateways that use the Transmission Control Protocol/Internet Protocol (TCP/IP) and other communication protocols, as well as application programming interfaces (APIs), to communicate with one another and with devices connected to the Data exchange network 199. One example data exchange network 199 includes the Internet, which can include data communication links between major nodes and/or host computers, including thousands of commercial, governmental, educational, and other computer systems that route data and messages. FIG. 1 is one example of an environment of the invention and is not an architectural limitation for different illustrative embodiments of the invention.

Clients and servers are only example roles of certain data processing systems and computer systems connected to data exchange network 199 which do not exclude other configurations or roles for these data processing systems. Dynamic credit limit server 130 and buyer server 150 connect to data exchange network 199 along with sources of fast data 160, 162, 164, 166, 168, 170 (which can include servers, databases, processors, and the necessary software and hardware to execute applications and methods for acquiring and sending fast data). Software applications can execute on any computer in the system 100. User computers (clients), including supplier computing device 110, are also connected to data exchange network 199. A data processing (computer) system, such as servers 130, 150 and clients 110, and data sources 160, 162, 164, 166, 168, 170 (and other connected devices) can include data and can have software applications and/or software tools executing on them.

FIG. 1 shows an example system architecture and shows certain components that are usable in an exemplary implementation of the invention. For example, servers 130, 150, 160, 162, 164, 166, 168, 170 and client 110 are depicted as servers and clients only as example and not to imply a limitation to a client-server architecture. In another example embodiment of the invention, the system 100 can be distributed across several data processing (computer) systems and a data network as shown. Similarly, in another example embodiment of the invention, the system 100 can be implemented on a single data processing system within the scope of the illustrative embodiments. Data processing (computer) systems 110, 130, 150, 160, 162, 164, 166, 168, 170 also represent example nodes in a cluster, partitions, and other configurations suitable for implementing an embodiment of the invention.

The supplier computers (e.g., 110) can take the form of a smartphone, a tablet computer, a laptop computer, a desktop computer, a wearable computing device, or any other suitable computing device and computers 130, 150, 160, 162, 164, 166, 168, 170 are typically servers, personal computers, and/or network computers. Software application programs described as executing in the system 100 in FIG. 1 can be configured to execute in user computers in a similar manner. Data and information stored or produced in another data processing system can be configured to be stored or produced in a similar manner.

Applications 111, 131, 151 implement an embodiment or function of the invention as described in this document. For example, dynamic credit limit application 131 receives a request from an application 111 on supplier computing device 110, including payment information such as currency, payment dates, selected invoices, and other supplier information. Applications 111, 112 of the supplier implements an embodiment or a function as described to operate in conjunction with applications 131, 132 on the dynamic credit limit server 130. For example, application 111 provides the supplier payment information used by dynamic credit limit application 131 to process, classify, and provide actionable dynamic credit limit funds. Similarly, buyer application 151 operates in conjunction with application 131 on the dynamic credit limit server 130 and provides invoices and ERP system records used by dynamic credit limit application 131 to process, classify, and provide actionable dynamic credit limit funds.

Computers 110, 130, 150, 160, 162, 164, 166, 168, 170, and additional computers (e.g., clients and servers), may couple to data exchange network 199 using wired connections, wireless communication protocols, or other suitable data connectivity.

In the depicted example, dynamic credit limit server 130 may provide data, such as boot files, operating system images, and applications to user computers (clients and servers) 110, 150. Client 110 may be clients to server 130 in this example. Client 110 and servers 150, 160, 162, 164, 166, 168, 170, or some combination, may include their own data, boot files, operating system images, and applications. System 100 may include additional servers, clients, and other devices that are not shown. For example, while countless point of sources of fast data can be used to provide inputs to the dynamic credit limit server using systems and methods constructed according to the principles and exemplary embodiments of the invention, for clarity and brevity, six distinct sources of fast data are shown with a single supplier computing device, a single buyer server, and a single dynamic credit limit server as shown in FIG. 1.

Among other uses, system 100 may be used for implementing a client-server environment in accordance with exemplary embodiments of the invention. A client-server environment enables software applications and data to be distributed across a network such that an application functions by using the interactivity between a user computer and a server. System 100 may also employ a service-oriented architecture, where interoperable software components distributed across a network can be packaged together as coherent applications.

Together, the system 100 provides inputs for the dynamic credit limit application 131 to process, classify, and provide actionable dynamic credit limit recommendations. More specifically, the supplier computer device 110 can use a supplier portal to provide to provide payment requests for chosen invoices. The system 100 uses inputs from buyer server 150, including ERP system 153, for example, as further inputs for the dynamic credit limit application 131. Additionally, sources 160, 162, 164, 166, 168, 170 provide fast data in real-time for use in determining the dynamic credit limit.

As inputs and results from supplier computing device 110, buyer server 150, and sources of fast data 160, 162, 164, 166, 168, 170 change in real-time, dynamic credit limit server 130 and application 131 constantly and continually reassess and redetermine the actionable dynamic credit limit.

### Glossary

The example systems and methods in accordance with the invention may be better understood by providing contextual meanings of some of the terms used in the examples of this disclosure as shown below.

L_{d}—Dynamic Credit Limit (“DCL”)—is the maximum amount, at a specific moment in time (current moment), of confirmed and scheduled for payment invoices issued to an individual Buyer that can be discounted/paid early by the supply chain finance provider;

Iᵢ—Issued invoice—amount of invoice issued by a Supplier to a Buyer (Account Debtor);

Iᵥ—Verified invoice—amount of invoice issued by a Supplier and the invoices' deliverables have been verified by the Buyer. Invoices with this level of approval are usually accepted for invoice finance funding such as factoring, invoice discounting, asset-based lending (ABL), etc.;

I_{c}—Confirmed Invoice—amount of invoice approved and scheduled for payment. Invoices with this level of approval are usually accepted for supply chain finance

I_{c}=Iᵥ−Δᵥ

where Δᵥ is pre-confirmation dilution (e.g., an amount of chargebacks, set-offs, counterclaims, withholdings, etc.);

Iₑ—early paid by supply chain finance confirmed invoice l_{c}

G_{c}—Gross amount of all confirmed invoices;

Gₑ—gross amount of all early paid by supply chain finance invoices;

P_{c}—Amount of payment received by supply chain finance provider for confirmed invoice

P_{c}=I_{c}−Δ_{c}

where Δ_{c} is the post-confirmation dilution (e.g., amount of unrelated credit-memos applied on the same date as invoice scheduled payment date, chargebacks, set-offs, etc.);

P_{g}—Amount of payment received by supply chain finance provider for all confirmed invoices G_{c};

D_{d}—Invoice due date;

Dₚ—invoice scheduled payment date;

Dₑ—supply chain finance early payment date;

Tₑ—Current payment period;

Tₙ—next payment period;

t_{d}—decision moment (milliseconds);

R_{c}—Amount of automatic recourse available in the current payment period T_{c}

R_{c}=P_{g}—Gₑ;

Rₙ—Amount of automatic recourse available in the next payment period Tₙ. Projected available automatic recourse is an amount of payments to be received from the same Buyer for non-funded invoices (P_{g} above DCL Id);

C_{b}—Base ceiling—initial maximum % of the total amount of Gₑ available for funding by SCF and established for a specific Buyer by the SCF underwriters;

dₐ—Discount—amount of discount taken and defined by supply chain finance provider and usually calculated as:

dₐ=d_{%}*Iₑ*(Dₚ−Dₑ)

where d_{%} is daily % discount;

Pₑ—Early payment amount of invoice paid by supply chain finance provider on early payment date Dₑ—discounted amount of Iₑ

Pₑ=Iₑ−dₐ

### Example System Operation and Methods:

The systems and methods of the invention establish a Dynamic Credit Limit L_{d} for a Supplier by performing real time (instant) and periodic analysis of major non-payment risks, including dilution risk, and create a dynamic risk mitigation structure in the form of an automatic recourse capability, including R_{c} the amount of automatic recourse available in the current payment period and Rₙ the amount of automatic recourse available in the next payment period.

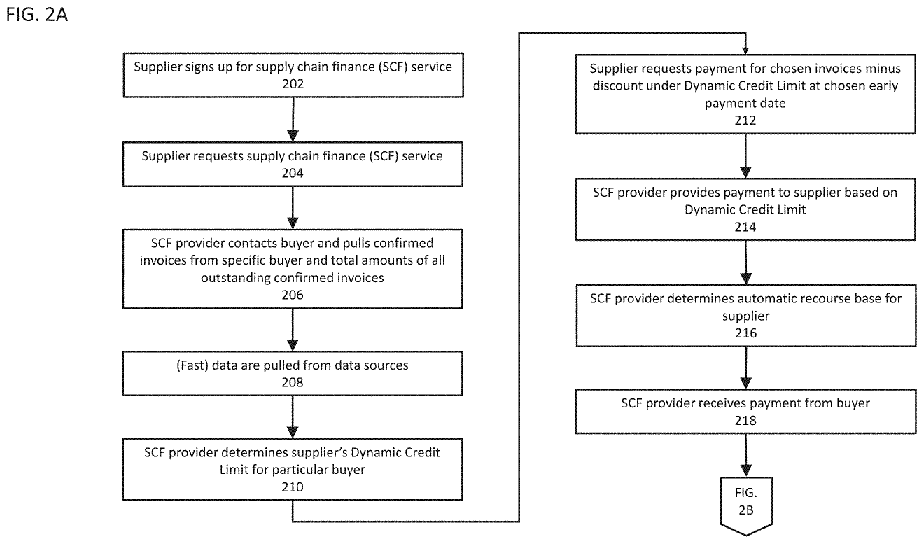

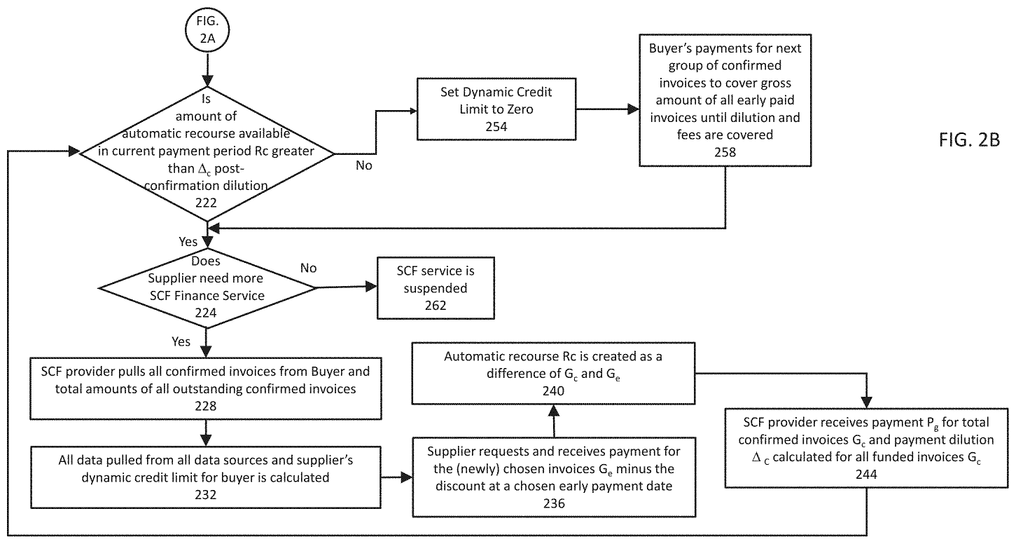

One example embodiment of the invention is shown in the system diagram of FIG. 1 and the process flow diagram of FIG. 2. The dynamic credit limit determination begins after block 202 when a supplier signs up for supply chain finance (SCF) service (A in FIG. 1). For clarity and brevity, “supplier” and “supplier computing device” may be thought of as a party selling goods or services to a buyer, and an example computer system used by a supplier is the supplier computing device 110 shown in FIG. 1. The process continues in block 204 when supplier 110 requests supply chain finance (SCF) service from the dynamic credit limit server 130 of supply chain finance provider (B in FIG. 1)

In block 206, the dynamic credit limit server 130 of supply chain finance provider contacts the specific buyer (server) 150 involved in the transactions with the supplier 110 (C1 in FIG. 1). The dynamic credit limit server 130 of supply chain finance provider receives/pulls confirmed invoices from the specific buyer (server) 150 (e.g., from the buyer ERP system 153) and receives the total (gross) amount of all outstanding confirmed invoices G_{c} (C2 in FIG. 1).

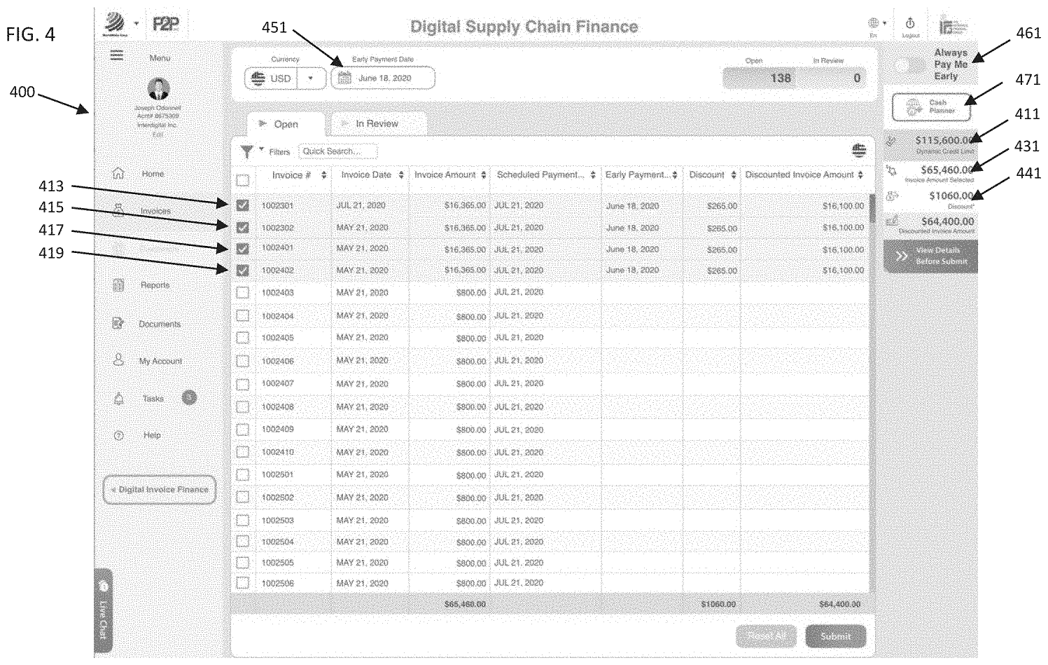

The example process continues in block 208 as the dynamic credit limit server 130 of supply chain finance provider receives/pulls fast data from a variety of sources of fast data 160, 162, 164, 166, 168, 170 (D1-D6 in FIG. 1). As outlined further below, in block 210, the dynamic credit limit server 130 of supply chain finance provider determines the supplier's Dynamic Credit Limit for the particular buyer 150 (E in FIG. 1) based on inputs from the buyer server ERP system 153, accounting software 113 of the supplier, and fast data from sources 160, 162, 164, 166, 168, 170. In many example implementations of the invention, the accounting software 113 of the supplier resides apart from the physical location of the supplier, as shown in FIG. 1 and behaves similarly to the fast data from sources 160, 162, 164, 166, 168, 170. FIG. 4 shows an example user interface screen 400 with the determined dynamic credit limit 411

Several contributing elements based on fast data analyzed by the dynamic credit limit application 131 can deliver binary conclusions like “yes” or “no.” For example, if during supply chain finance digital compliance processes (KYC, AML, CTF—know your customer, Anti-Money Laundering, and Counter Terrorism Financing, respectively) someone from a Supplier's management or ownership team is listed on an Office of Foreign Assets Control (OFAC) list, it will result in the Supplier's funding request being declined. On the other hand, for example, the level of confidence in a logged-in Supplier user's IP address or a user's geo-location or analysis of UCC/PPSR/Charges (i.e., Uniform Commercial Code, Personal Property Securities Register, etc.) and collateral descriptions for a Supplier will contribute to the relevant segment's element (risk score) scoring, resulting in a decrease of the final current Dynamic Credit Limit L_{d} level, instead of rejection of the funding request.

In block 212, Supplier 110 requests payment for chosen invoices Gₑ (i.e., the gross amount of all early paid by supply chain finance invoices) minus a discount. As an example, the invoices chosen are shown as reference numerals 413, 415, 417, 419 on the user interface screen 400 of FIG. 4, and the discount is shown as reference numeral 441. The payment amount must be less than or equal to the dynamic Credit Limit 411 determined by the dynamic credit limit server 130 of supply chain finance provider. The user interface screen 400 in FIG. 4 shows the invoice amounts selected 431 as the supplier identifies invoices for early payment. Along with the payment amount, the supplier 110 choses an early payment date (F in FIG. 1) and shown as reference numeral 451 in FIG. 4.

The process continues in block 214 as the dynamic credit limit server 130 of supply chain finance provider provides (early) payment for the chosen invoices to the supplier 110 (G in FIG. 1). At the same time, in block 216, the dynamic credit limit server 130 of supply chain finance provider determines an automatic recourse base R_{c}, which is the amount of automatic recourse available in the current payment period, for the supplier as a difference between the gross amount of all outstanding confirmed invoices (G_{c}) and the gross amount of all early paid by supply chain finance invoices Gₑ (H in FIG. 1).

In block 218, the dynamic credit limit server 130 of supply chain finance provider receives payment P_{g} (i.e., the amount of payment received by the supply chain finance provider for all confirmed invoices) from the buyer 150 for total confirmed invoices G_{c} and payment dilution Δ_{c} calculated for all funded (confirmed outstanding) invoices G_{c} (J in FIG. 1).

In one example implementation of the invention, for dilution risk calculations, the process performed by the dynamic credit limit server 130 of supply chain finance provider constantly and continually receives and analyzes historical dilution data of the Supplier with the individual Buyer and can use ML (machine learning) for dilution prediction providing systems the ability to automatically learn and improve from experience without being explicitly programmed. Machine learning determinations of predicting dilution focuses on the development of computer programs that can access data and use it learn to refine dilution calculations and predictions themselves.

For example, the dynamic credit limit server 130 may receive fast data dilution predictions based on machine learning modules, applications, and systems for identifying relationships and invoice/payment histories for use in calculations by the dynamic credit limit server 130 for decisions relating to setting a dynamic credit limit. The dynamic credit limit server can include machine learning (ML) modules for receiving the dilution prediction generated by the models and to incorporate the information in determining the dynamic credit limit.

Beside the dilution risk, the systems and methods of the invention manage a number of other types of Supplier risks, including but not limited to, fraud/threat, credit risk, liens (including registered secured interests and collateral descriptions), CCJs and pending litigations, tax liens, compliance, etc.

These non-dilution risks are important because they can significantly impact current and future payments from the Buyer to the Supplier and the ability to structure a sustainable recourse base to mitigate risks and prevent real losses. For example, understanding how stable the Supplier's business is at the decision point t_{d} and the ability to predict if the Supplier will be able to deliver its goods and/or services to the Buyer next month and beyond figures prominently in determining the dynamic credit limit. Examples of the consideration and effects of these risks are outlined further below.

The overall process continues in FIG. 2B as additional comparisons, calculations, and determinations are made by the dynamic credit limit server 130 of supply chain finance provider when supplier 110 is in need of additional funds. For example, continuing with block 222 in FIG. 2B, the dynamic credit limit server 130 of supply chain finance provider compares the amount of automatic recourse available in the current payment period R_{c} to Δ_{c} the post-confirmation dilution. If the post-confirmation dilution is less than the automatic recourse available in the current payment period, the process continues to block 224 as described below. However, if the post-confirmation dilution is greater than the automatic recourse available in the current payment period, the process continues to block 254, and the dynamic credit limit is set to zero. The process continues to block 258 where the buyer's payments for the next group of confirmed invoices Rₙ is used to cover the gross amount of all early paid by SCF invoices Gₑ until dilution and fees are fully covered. The process then continues to block 224.

The process in block 224 determines if the supplier requests additional supply chain finance service. If no, the supply chain finance service is suspended in block 262, and the process ends. However, when the supplier does need additional supply chain finance service in block 224, the process continues to block 228, where the supply chain finance provider pulls all confirmed invoices from the buyer and total amounts of all outstanding confirmed invoices G_{c}. All data are pulled from all sources of fast data, and the supplier's dynamic credit limit is (re)calculated in block 232.

In block 236, the supplier selects an early payment date and requests (and receives) payment for (newly) chosen invoices Gₑ less the discount, and the total is less than the recalculated dynamic credit limit. In block 240, a new automatic recourse Rc is created as a difference between the total amounts of all outstanding confirmed invoices G_{c} and the gross amount of all early paid by SCF invoices Gₑ.

In block 244, the supply chain finance provider receives payment P_{g} for the total of all confirmed invoices G_{c} and payment dilution & that was calculated for all funded confirmed invoices G_{c}. The process then returns to block 222 and cycles through until the supplier no longer needs additional supply chain finance service, and service is suspended.

An additional example with simplified amounts provides additional insights into the systems and methods of the invention. One example includes a Supplier's request for early payment. At the specific moment t_{d}, this Supplier has $1M of confirmed invoices G_{c} issued to a specific Buyer. As a result of the automatic analysis based on current fast data, including financial data pulled from the Supplier's accounting software, historical dilution data pulled from the Buyer's ERP server, and data pulled from the different fast data sources, including Credit Bureaus, different government agencies, compliance/fraud/threat data aggregators, PPSR/PPSA systems and UCC filing data pulled from Secretary of State databases, etc. The automatic analysis includes predicted dilution &, where predicted dilution is calculated based on machine learning (ML) modules trained by significant data of billing and correspondent payments ($ trillions) from 1st tier Buyers to their Suppliers in different industries, jurisdictions, economic cycles, etc. The machine learning (ML) models can then be used to further process the fast data, including billings of suppliers and payments of buyers, to determine the dilution prediction. Example machine learning engines (ML) include Google TensorFlow or BERT, and other engines. In this example, the dynamic credit limit (DCL) Ld is set at a level of $912 K.

This means that the Supplier can discount any invoices up to $912 K and the supply chain finance provider will provide early payment Pₑ to the Supplier on the early payment date Dₑ and will take a discount payment of dₐ. For example, dₐ is calculated as 1% for 30 days daily prorated discount. All payments from the Buyer for all invoices, P_{g} are assigned and paid to a dedicated account controlled by the supply chain finance provider (via assignment of debts). So, in an event where payments for the funded $912 K invoices are diluted, the dilution Δ_{c} will be covered automatically from payments received for $88 K in non-funded invoices R_{c}. If the amount of current recourse R_{c} is not enough to cover the dilution Δ_{c}, then the dynamic credit limit (DCL) will be set to $0 and deficit will be covered from the next payment period for non-funded invoices Rₙ as shown in FIG. 2B. Immediately after this, the Supplier will again be able to request early payments under the new dynamic credit limit DCL L_{d}.

The systems and methods of the invention provide digital supply chain finance service on a recourse basis, and in cases where the supply chain finance provider is unable to cover dilution Δ_{c} by automated current recourse R_{c} and next payment period recourse Rₙ, they can exercise full recourse rights and demand payments from any other receivables that the Supplier has or will have in future. The supply chain finance provider registers its security interest and is a secure creditor to the Supplier.

### Dynamic Credit Limit Determination Example:

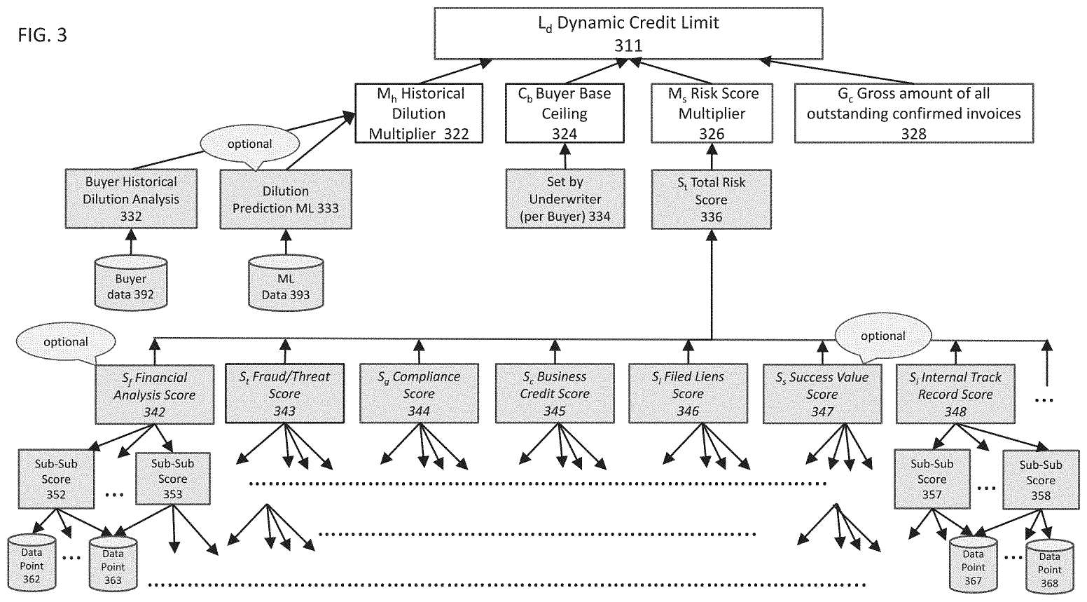

FIG. 3 shows an example of a scoring scheme to quantify aspects of fast data received by the dynamic credit limit and recourse base systems in accordance with the invention. In the example shown in FIG. 3, the dynamic credit limit 311 is determined based on a total amount of all outstanding confirmed invoices 328, a historic dilution multiplier 322, a buyer base ceiling 324, and a risk score multiplier 326. FIG. 3 can be understood as showing a loose hierarchy of scores/sub-scores and sources of fast data that contribute to the dynamic credit limit determinations. Successive lower “layers” in FIG. 3 show elements contributing to the components above them. As outlined above, a dynamic credit limit L_{d} for a specific Supplier is calculated at every decision moment t_{d} and is based on real time fast data pulled from thousands of data points, for example financial information from Supplier accounting software, data from Credit Bureaus, and other sources of fast data as shown in FIGS. 1 and 3. In one example implementation of the invention, a dynamic credit limit L_{d} 311 is determined using a gross amount of all confirmed invoices G_{c} 328 as well as a historic dilutions multiplier Mₕ 322 (see below), a risk score multiplier Mₛ 326 (also described further below), and a base ceiling C_{b}324. Both the historic dilutions multiplier Mₕ 322 and the risk score multiplier Mₛ 326 are applied to the base ceiling C_{b}324. The base ceiling C_{b} 324 is an initial maximum % of the total gross amount of all confirmed invoices available for funding by the supply chain finance system. The base ceiling C_{b} 324 is established for a specific Buyer by the supply chain finance underwriters 334. In an example embodiment of the invention, the dynamic credit limit 311 is determined based on the following relationship.

L_{d}=G_{c}*(C_{b}*Mₕ*Mₛ)

where

Mₕ—historical dilutions multiplier (in %) which is applied to base ceiling C_{b}.

Continuing with FIG. 3, Mₕ 322 is calculated as the result of statistical analysis of historical dilution events 332 for a period, based on data constantly pulled from the Buyer ERP system 392, and contributions from ML dilution prediction for specific Buyer-Supplier pairs as reference numeral 393 shown in FIG. 3. The dilution prediction 333 is determined based on machine learning (ML) trained by significant data of billing and correspondent payments (in $ trillions) from 1st tier Buyers to their Suppliers in different industries, jurisdictions, economic cycles, etc., The machine learning models can then be used to further process the fast data, including billings of suppliers and payments of buyers, to determine the dilution prediction 333. Example machine learning models engines (ML) include Google TensorFlow, Google BERT, and other engines.

Mₛ—risk score multiplier (in %) which is applied to base ceiling C_{b}.

Continuing with the example dynamic credit limit determination outlined in the FIGS., risk score multiplier Mₛ 326 is equal to a percent from 0% to 100% depending on what the total risk score 336 is. For example, if the total risk score Sₜ 336 is higher than 450, then the risk score multiplier Mₛ 326 is equal to 100%. Similarly, if the total risk score Sₜ score 336 is lower than 25, then the risk score multiplier Mₛ 326 is equal to 0%. The supply chain finance provider can establish the strata of risk score multipliers Mₛ 326 equating them to the total risk scores Sₜ 336.

As outlined above, total risk score Sₜ 336 is used to determine the risk score multiplier 326. In turn, the total risk score Sₜ 336 is made up of many different scores determined from the constant and continuing analysis of fast data. In one example implementation of the invention, the total risk score 336 is determined based on a financial analysis score 342, a fraud/threat (trust) score 343, a compliance score 344, a business credit score 345, a filed liens score 346, a success value score 347, an internal track record score 348, and other scores based on received fast data.

While the financial analysis score 342 and the success value score 347 are shown in FIG. 3 as optional, the total risk score Sₜ 336 can include more or less fast data from many sources.

In an example embodiment of the invention, the total risk score 336 is determined based on the following relationship.

Sₜ—is the total risk score (maximum value is 500)

Sₜ=(S_{f}*Wₛ*S_{g}*W₃+S_{c}*W₄+Sₗ*W₅+Sₛ*W₆Sᵢ*W₇+ . . . Sₓ*Wₓ)/Σ(Wᵢ)

where

Sₜ is Financial Analysis score,

Sₜ is Fraud/Threat (trust) score,

S_{g} is Compliance score,

S_{c} is Business Credit score,

Sₗ is Filed Liens score,

Sₛ is Success/Social Value score,

Sᵢ is SCF Internal Historical Track Record score,

Sₓ is any additional customized score(s) which could be added, if necessary, by the supply chain finance provider and the weighting factors (W₁, W₂, etc.) are applied to each of the respective scores.

Wᵢ is a weight factor, which has a value from 0 to 5 and could be dynamic, depending on the value of the applicable score.

Each of the scores can be weighted by the supply chain finance provider and assigned a weight factor. For example, weighting the individual scores (e.g., financial analysis score, fraud/threat (trust) score, compliance score, business credit score, filed liens score, success value score, internal track record score, and customized scores) that make up the total risk score provides a method of prioritizing scores and determining a relative value of that score's contribution to the total risk score. In one example implementation of the invention, criteria for weighting is selected by analyzing statistics and identifying characteristics of each score's correlation to the total risk score. The weight for each score is assigned in the range from 0 to 5. The most important score (i.e., that score or scores that have the strongest correlation to the total risk score and make the largest contribution to the total (aggregate) risk score) is weighted 5, and less important scores (i.e., that score or scores that have the weakest correlation to the total risk score and makes the smallest contribution to the total aggregate score) is weighted 1. The weights can be statically applied to each of the scores, sub-scores, sub-sub-scores, etc. or can be dynamically determined and applied based on received fast data.

The individual scores 342, 343, 344, 345, 346, 347, 348 are based on the received fast data that is continually processed by the system. In some instances, the system determines a number of sub-scores for the scores based on the fast data. In FIG. 3, an example is shown where Financial Analysis Score 342 is determined based on sub-scores (and similarly, on sub-sub-scores). While determining a Financial Analysis score S_{f} is optional, it can be calculated based on analysis of the Supplier's financial data, if available, including Profit and Loss Statements, Balance Sheets, AR Aging and AP Aging reports, and other financial information instantly pulled from the Supplier's accounting software (e.g., 113 in FIG. 1) or automatically extracted from Suppliers reports uploaded to the supply chain finance provider's platform in any format, including from sources of fast data. In FIG. 3, a Profit and Loss Statement (shown as reference numeral 362 in FIG. 3) may result in a sub-sub-score 352. Similarly, fast data (shown as reference numeral 363) may be used to determine another sub-sub-score 353, such as an A/R concentration, or other measures of the supplier's financial position.

In practice, the financial analysis score S_{f} 342 may be more important for invoice finance services than for supply chain finance services, since there is no verifiable historical dilution data which exists for invoice finance. That is why for supply chain finance services, financial analysis score S_{f} 342 may not be as important as buyer historical dilution analysis 332 (and the resulting historical dilution multiplier 322), which is a more determinative component for the dynamic credit limit determination. In any case, when a financial analysis score S_{f} 342 is available for supply chain finance services then it is calculated as:

S_{f}=(S_{f1}*W₁+S_{f2}*W₂+S_{f3}*W₃+S_{f4}*W₅+S_{f6}*W₆+S_{f7}*W₇+S_{f8}*W₈+S_{f9}*W₉+S_{f10}*W₁₀S+f₁₁*W₁₁)/Σ(Wᵢ)

where

S_{f1} is extrapolated income score, that can be based on past earnings statements, income from previous time frames, and other measures.

S_{f2} is Equity/Income ratio score,

S_{f3} is Assets/Liability ratio score,

S_{f4} is AR/Monthly Revenue ratio score,

S_{f5} is Total AP/AR ratio score,

S_{f6} is AP/AR 0 to 30 days ratio score,

S_{f7} is AP/AR 30 to 60 days ratio score,

S_{f8} is AP/AR 60 to 90 days ratio score,

S_{f9} is AP/AR over 90 days ratio score,

S_{f10} is Highest AR Concentration score,

S_{f11} is Reporting Period score and

Wᵢ is a weight factor.

Each of the sub-scores can be weighted by the supply chain finance provider, and the weighting factors (W₁, W₂, etc.) are applied to each of the respective sub-scores. As before, weighting the individual sub-scores that make up the total financial analysis score provides a method of prioritizing sub-scores and determining a relative value of that sub-score's contribution to the total financial analysis score. In one example implementation of the invention, criteria for weighting is selected by analyzing statistics and identifying characteristics of each sub-score's correlation to the total financial analysis score. The weight for each sub-score is assigned in the range from 1 to 5. The most important sub-score (i.e., that sub-score or sub-scores that have the strongest correlation to the total financial analysis score and make the largest contribution to the financial analysis score) is weighted 5, and less important scores (i.e., that sub-score or sub-scores that have the weakest correlation to the total financial analysis score and makes the smallest contribution to the financial analysis aggregate score) is weighted 1. The weights can be statically applied to each of the sub-scores, or can be dynamically determined and applied based on received fast data.

The fraud/threat score Sₜ 343 is used in the dynamic credit limit determination to assess, identify, understand, and ultimately account for risks of fraud to the supply chain finance service provider. These risks can include fraudulent disbursements, undisclosed relationships, theft by cyber-fraud, false qualifications or certifications, compliance with government regulations, improper reporting and disclosures, identity theft, and other fraud risks. The fraud threat score St 343 is based on received fast data that is continually processed by the system. In some instances, the system determines of sub-scores that, in aggregate, make up the fraud/threat score. In FIG. 3, an example is shown where fraud threat score St 343 is determined based on sub-scores (e.g., the sub-scores sₜᵢ-sₜ₁₁ described below). In FIG. 3, the arrows extending downward from fraud/threat score 343 indicate further sub-sub-scores and respective sources of fast data used to determine the sub-sub-scores). In one example of the invention, determining a Fraud/Threat Score Sₜ is calculated based on the following relationship:

Sₜ=(Sₜ₁*W₁+Sₜ₂*W₂+Sₜ₃*W₃+Sₜ₄*W₄+Sₜ₅W₅+Sₜ₆*W₆+Sₜ₇*W₇+Sₜ₈*W₈+Sₜ₉*W₉+Sₜ₁₀*W₁₀+Sₜ₁₁+Sₜ₁₁W₁₁)/Σ(Wᵢ)

where

Sₜ₁ is Email Risk score, calculated based on the email address age,

Sₜ₂ is IP Address Confidence score, calculated based on the data for historical IP address fraudulent use,

Sₜ₃ is IP Address Risk score, calculated based on location IP address and Supplier location,

Sₜ₄ is Proxy/VPN/TOR score, calculated based on analysis of direct or non-direct connection,

Sₜ₅ is Email Free/Corporate score, calculated based on a fact that user is using corporate email address or free email address like g-mail, yahoo, etc.,

Sₜ₆ is City Confidence Score, calculated based on location of city and proximity to Supplier's address,

Sₜ₇ is Geolocation score, calculated based on physical user's address and IP address,

Sₜ₈ is Location Accuracy Radius score, calculated based on Supplier's business location and user IP address distance (radius),

Sₜ₉ is Location Average Income score, calculated based on the weighted average income in US dollars per person for the zip/post code(s) associated with the IP address,

Sₜ₁₀ is Postal Confidence score, calculated based on business accounts (credit cards) address and user address,

Sₜ₁₁ is Address/Phone Residential/Business score, calculated based on user connection location (office or home), and

Wᵢ is a weight factor.

Each of the sub-scores can be weighted by the supply chain finance provider, and the weighting factors (W₁, W₂, etc.) are applied to each of the respective sub-scores. As before, weighting the individual sub-scores that make up the total fraud/threat score provides a method of prioritizing sub-scores and determining a relative value of that sub-score's contribution to the total fraud/threat score. In one example implementation of the invention, criteria for weighting is selected by analyzing statistics and identifying characteristics of each sub-score's correlation to the total fraud/threat score. The weight for each sub-score is assigned in the range from 1 to 5. The most important sub-score (i.e., that sub-score or sub-scores that have the strongest correlation to the total fraud/threat score and make the largest contribution to the fraud/threat score) is weighted 5, and less important scores (i.e., that sub-score or sub-scores that have the weakest correlation to the total fraud/threat score and makes the smallest contribution to the fraud/threat aggregate score) is weighted 1. The weights can be statically applied to each of the sub-scores, or can be dynamically determined and applied based on received fast data.

The compliance score S_{g} 344 is used in the dynamic credit limit determination to assess, identify, understand, and ultimately account for risks of non-compliance. These risks can include know your customer (“KYC”) non-compliance, anti-money laundering (“AML”) non-compliance, counter-terrorism financing (“CTF”) non-compliance and other compliance risks. The compliance score S_{g} 344 is based on received fast data that is continually processed by the system. In some instances, the system determines of sub-scores that, in aggregate, make up the compliance score S_{g} 344. In FIG. 3, an example is shown where compliance score S_{g} 344 is determined based on sub-scores (e.g., the sub-scores sₒ-sₒ described below). In FIG. 3, the arrows extending downward from compliance score 344 represent further sub-sub-scores and respective sources of fast data used to determine the sub-sub-scores). In one example of the invention, determining a Compliance Score S_{g} is determined by the following relationship:

S_{g}=(S_{g1}*W₁+S_{g2}*W₂+S_{g3}*W₃S_{g4}W₄+S_{g5}*W₅)/Σ(Wᵢ)

where

S_{g1} is International Watchlist score, calculated based on OFAC sanctions list and/or international sanctions lists,

S_{g2} is Enhanced Credit score, calculated based on combination of the data from one or more registered credit agencies and is augmented with one or more of the following; utility, electoral roll, and driver's license or passport's data,

S_{g3} is Passport/Driver License/ID Validation score, calculated based on validation of personal IDs,

S_{g4} is Address Validation score, calculated based on user home address validation,

S_{g5} is Utility score and calculated based on correlation of Utility bills with user address,

W₁ is a weight factor.

Similar to the above determinations, each of the sub-scores can be weighted by the supply chain finance provider, and the weighting factors (W₁, W₂, etc.) are applied to each of the respective sub-scores. As before, weighting the individual sub-scores that make up the total compliance score provides a method of prioritizing sub-scores and determining a relative value of that sub-score's contribution to the total compliance score. In one example implementation of the invention, criteria for weighting is selected by analyzing statistics and identifying characteristics of each sub-score's correlation to the total compliance score. The weight for each sub-score is assigned in the range from 1 to 5. The most important sub-score (i.e., that sub-score or sub-scores that have the strongest correlation to the total compliance score and make the largest contribution to the compliance score) is weighted 5, and less important scores (i.e., that sub-score or sub-scores that have the weakest correlation to the total compliance score and makes the smallest contribution to the compliance aggregate score) is weighted 1. The weights can be statically applied to each of the sub-scores, or can be dynamically determined and applied based on received fast data.

While outlined above, each sub-component of the contributing component score has its own contributing sub-sub-components, and the sub-sub-scores corresponding to that sub-sub-component combine to determine the aggregate sub-score. As alluded above, for example, Passport/Driver License/ID Validation score S_{g3} can be determined according to the relationship:

S_{g3}=(S_{g31}*W₁+S_{g32}*W₂+S_{g33}*W₃+S_{g34}*W₄+S_{g35}W₅)/Σ(Wᵢ)

where

S_{g31} is Authentication Result score,

S_{g32} is ID Passed/Failed/Unknown score,

S_{g33} is Total ID Verification score,

S_{g34} is ID Barcode Verification score,

S_{g35} is ID Data Extraction Reliability Level score and

Wᵢ is a weight factor.

As with the determinations of the sub-scores and their corresponding weights, each of the sub-sub-scores can be weighted by the supply chain finance provider, and the weighting factors (W₁, W₂, etc.) are applied to each of the respective sub-sub-scores. As before, weighting the individual sub-sub-scores that make up the total Passport/Driver License/ID Validation sub-score S_{g3} provides a method of prioritizing sub-sub-scores and determining a relative value of that sub-sub-score's contribution to the total Passport/Driver License/ID Validation sub-score S_{g3}. In one example implementation of the invention, criteria for weighting is selected by analyzing statistics and identifying characteristics of each sub-sub-score's correlation to the total Passport/Driver License/ID Validation sub-score S_{g3}. The weight for each sub-sub-score is assigned in the range from 1 to 5. The most important sub-sub-score (i.e., that sub-sub-score or sub-sub-scores that have the strongest correlation to the total Passport/Driver License/ID Validation sub-score S_{g3} and make the largest contribution to the Passport/Driver License/ID Validation sub-score S_{g3}) is weighted 5, and less important scores (i.e., that sub-sub-score or sub-sub-scores that have the weakest correlation to the total Passport/Driver License/ID Validation sub-score S_{g3} and makes the smallest contribution to the Passport/Driver License/ID Validation aggregate sub-score S_{g3}) is weighted 1. The weights can be statically applied to each of the sub-scores, or can be dynamically determined and applied based on received fast data.

The (business) credit risk score S_{c} 345 is used in the dynamic credit limit determination to quantify and account for risks of a supplier's overall ability to repay in case of recourse. To assess credit risk, the systems and methods of the invention evaluate fast data related to credit history, ability to continue to provide service to Buyer, capacity to repay. The credit risk score S_{c} 345 is based on received fast data that is continually processed by the system. In some instances, the system determines of sub-scores that, in aggregate, make up the credit risk score S_{c} 345. In FIG. 3, an example is shown where credit risk score S_{c} 345 is determined based on sub-scores (e.g., the sub-scores s_{c1}-s_{c6} described below). In FIG. 3, the arrows extending downward from credit risk score S_{c} 345 represent further sub-sub-scores and respective sources of fast data used to determine the sub-sub-scores). In one example of the invention, determining a Credit Risk Score S_{c} 345 is determined by the following relationship:

S_{c}=(S_{c1}*W₁+S_{c2}*W₂+S_{c3}*W₃+S_{c4}*W₄+S_{c5}*W₅+S_{c6}*W₆)/Σ(Wᵢ)

where

S_{c1} Active Registration/Time in Business score, calculated based on time in business,

S_{c2} is Derogatoriness score, calculated based on analysis of derogatoriness data,

S_{c3} is Insolvency History score, calculated based on historical insolvency events,

S_{c4} is Collection/Revenue Ratio score, calculated based on the current amount in collection to Revenue,

S_{c5} is Tax Liens/CCJ History score, calculated based on analysis of the liens placed against the supplier and historical judgments against the supplier,

S_{c6} is Trade Names Score, calculated based on the history and numbers of the trade names used by supplier, and

Wᵢ is a weight factor.

Similar to the above determinations, each of the sub-scores can be weighted by the supply chain finance provider, and the weighting factors (W₁, W₂, etc.) are applied to each of the respective sub-scores. As before, weighting the individual sub-scores that make up the total credit risk score provides a method of prioritizing sub-scores and determining a relative value of that sub-score's contribution to the total credit risk score. In one example implementation of the invention, criteria for weighting is selected by analyzing statistics and identifying characteristics of each sub-score's correlation to the total credit risk score. The weight for each sub-score is assigned in the range from 1 to 5. The most important sub-score (i.e., that sub-score or sub-scores that have the strongest correlation to the total credit risk score and make the largest contribution to the credit risk score) is weighted 5, and less important scores (i.e., that sub-score or sub-scores that have the weakest correlation to the total credit risk score and makes the smallest contribution to the credit risk aggregate score) is weighted 1. The weights can be statically applied to each of the sub-scores, or can be dynamically determined and applied based on received fast data.

The filed liens score Sₗ 346 is used in the dynamic credit limit determination to quantify and account for risks of a supplier's assets being subject to another party's security interest and their priorities. Filed liens imply a claim or legal right against assets that are typically used as collateral to satisfy a debt. If the underlying obligation is not satisfied, the creditor may be able to seize the assets that are the subject of the lien. To assess filed liens and pledged collaterals, the systems and methods of the invention evaluate fast data related to lien filings, and the various types of collateral identified in the lien. The filed liens score Si 346 is based on received fast data that is continually processed by the system. In some instances, the system determines of sub-scores that, in aggregate, make up the filed liens score Sₗ 346. In FIG. 3, an example is shown where filed liens score Sₗ 346 is determined based on sub-scores (e.g., the sub-scores sₗ₁-sₗ₆ described below). In FIG. 3, the arrows extending downward from filed liens score Sᵢ 346 represent further sub-sub-scores and respective sources of fast data used to determine the sub-sub-scores). In one example of the invention, determining a Filed Liens Score Sₗ is calculated as according to the following relationship:

Sₗ=(Sₗ₁*W₁+Sₗ₂*W₂+Sₗ₃*W₃+Sₗ₄*W₄Sₗ₅*W₅+Sₗ₆*W₆)/Σ(Wᵢ)

where

Sₗ₁ Total Number of Not-Terminated Filings (UCC/PPSR/Charges) score, calculated based on filed number of security interest liens,

Sₗ₂ is Number of Not-Terminated Filings (AR/Debtors) score, calculated based on filed number of security liens with collateral description which includes Accounts or Accounts Receivable or Debtors,

Sₗ₃ is Not-Terminated Filings (Inventory) score, calculated based on filed number of security liens with collateral description which includes inventory,

Sₗ₄ is Not-Terminated Filings (PMSI) score, calculated based on filed number of security liens with collateral description which includes purchase money security interest (“PMSI”),

Sₗ₅ is Not-Terminated Filings (All Assets) score, calculated based on filed number of security liens with collateral description which includes all assets,

Sₗ₆ is the Alternate Payee Score calculated based on existence of an active assignment of payment to third party, and

Wᵢ is a weight factor.

Similar to the above determinations, each of the sub-scores can be weighted by the supply chain finance provider, and the weighting factors (W₁, W₂, etc.) are applied to each of the respective sub-scores to determine the overall filed liens score Sₗ 346. As before, weighting the individual sub-scores that make up the total filed liens score Sₗ 346 provides a method of prioritizing sub-scores and determining a relative value of that sub-score's contribution to the total filed liens score Sₗ 346. In one example implementation of the invention, criteria for weighting is selected by analyzing statistics and identifying characteristics of each sub-score's correlation to the total filed liens score Sₗ 346. The weight for each sub-score is assigned in the range from 1 to 5. The most important sub-score (i.e., that sub-score or sub-scores that have the strongest correlation to the total filed liens score Sₗ 346 and make the largest contribution to the filed liens score Sₗ 346) is weighted 5, and less important scores (i.e., that sub-score or sub-scores that have the weakest correlation to the total filed liens score Sₗ 346 and makes the smallest contribution to the filed liens aggregate score Sₗ 346) is weighted 1. The weights can be statically applied to each of the sub-scores, or can be dynamically determined and applied based on received fast data.

The success/social value score Sₛ 347 is also used in the dynamic credit limit determination to quantify and account for positive and negative effects which major shareholders and/or executive officers make on the supplier. The goal of this metrics is to use positive social impact to increase inclusivity and access to capital for suppliers. The success/social value score Sₛ 347 is a proxy to an often qualitative value of the supplier, one that has been often measured with non-financial indicators. The success/social value score Sₛ 347 is based on received fast data that is continually processed by the system. In some instances, the system determines of sub-scores that, in aggregate, make up the success/social value score Sₛ 347. In FIG. 3, an example is shown where success/social value score Sₛ 347 is determined based on sub-scores (e.g., the sub-scores sₛ₁-sₛ₅₆ described below). In FIG. 3, the arrows extending downward from success/social value score Sₛ 347 represent further sub-sub-scores and respective sources of fast data used to determine the sub-sub-scores). In one example of the invention, determining a Success/Social Value score Sₛ is calculated as according to the following relationship:

Sₛ=(Sₛ₁*W₁+Sₛ₂*W₂+Sₛ₃*W₃+Sₛ₄*W₄+Sₛ₅*W₅)/Σ(Wᵢ)

where

Sₛ₁ is Level of Education score, calculated based on user historical education data,

Sₛ₂ is Career score, calculated based on historical career data,

Sₛ₃ is Loyalty score, calculated based on analysis of professional commitment (level of continues effort to achieve the goal vs constantly jumping from project to project),

Sₛ₄ is Social Activity score, calculated based on analysis of data connected to community, charities, and other social activities,

Sₛ₅ is Reputation score calculated based on analysis of user reputational data, and

Wᵢ is a weight factor.

As above, each of the sub-scores can be weighted by the supply chain finance provider, and the weighting factors (W₁, W₂, etc.) are applied to each of the respective sub-scores to determine the overall success/social value score Sₛ 347. As before, weighting the individual sub-scores that make up the total success/social value score Sₛ 347 provides a method of prioritizing sub-scores and determining a relative value of that sub-score's contribution to the total success/social value score Sₛ 347. In one example implementation of the invention, criteria for weighting is selected by analyzing statistics and identifying characteristics of each sub-score's correlation to the total success/social value score Sₛ 347. The weight for each sub-score is assigned in the range from 1 to 5. The most important sub-score (i.e., that sub-score or sub-scores that have the strongest correlation to the total success/social value score Sₛ 347 and make the largest contribution to the success/social value score Sₛ 347) is weighted 5, and less important scores (i.e., that sub-score or sub-scores that have the weakest correlation to the total success/social value score Sₛ 347 and makes the smallest contribution to the success/social value score Sₛ 347) is weighted 1. The weights can be statically applied to each of the sub-scores, or can be dynamically determined and applied based on received fast data.

In this example, weight factor Wᵢ is a dynamic factor determined as fast data is received. Weight factor Wᵢ is much lower when the overall success/social value score Sₛ 347 is lower than 350 and much higher when the overall success/social value score Sₛ 347 is from 351 to 500.

SCF Internal Historical Track Record score Sᵢ 348 is also used in the dynamic credit limit determination to quantify and account for past supplier-supply chain finance provider interactions. The interactions can include longevity of the business relationship, historical payment defaults by the supplier (i.e., payments from the supplier to the supply chain finance service provider in case of recourse), characteristics of the selected invoices requested for early payment (e.g., amounts, timeframes, etc.), and other supply chain finance internal historical track record items. The SCF Internal Historical Track Record score S₁348 is based on internal supply chain finance provider's data that is continually analyzed by the system. In some instances, the system determines of sub-scores that, in aggregate, make up the SCF Internal Historical Track Record score Sᵢ 348. In FIG. 3, an example is shown where SCF Internal Historical Track Record score Sᵢ 348 is determined based on sub-sub-scores 357, 358 (e.g., the sub-scores sᵢ₁-sᵢ₅ described below). In FIG. 3, the arrows extending downward from SCF Internal Historical Track Record score Sᵢ 348 represent further sub-sub-scores and respective sources 367, 368 of data used to determine the sub-sub-scores). In one example of the invention, determining a SCF Internal Historical Track Record score Sᵢ 348 is calculated according to the following relationship:

Sᵢ=(Sᵢ₁*W₁+Sᵢ₂*W₂+S₃*W₃+Sᵢ₄*W₄+Sᵢ₅*W₅)/Σ(Wᵢ)

where

Sᵢ₁ Longevity of the Account score, calculated based on longevity history with supply chain finance provider

Sᵢ₂ is Defaults Number/Transactions Number Ratio score, calculated based on supplier Defaults Number/Transactions Number Ratio historically occurred with supply chain finance provider funding,

Sᵢ₃ is Total Δ_{c}/Total Gₑ Ratio score, calculated based on supplier Total Δ_{c}/Total Gₑ Ratio historically occurred with supply chain finance provider funding,

Sᵢ₄ is Total Δ_{c}/Total (R_{c}+Rₙ) Ratio score, calculated based on supplier Total Δ_{c}/Total (R_{c}+Rₙ) Ratio historically occurred with supply chain finance provider funding,

Sₛ₅ is Total G_{c} score calculated based on supplier Total G_{c} score historically occurred with supply chain finance provider funding, and

Wᵢ is a weight factor.

As above, each of the sub-scores can be weighted by the supply chain finance provider, and the weighting factors (W₁, W₂, etc.) are applied to each of the respective sub-scores to determine the overall SCF Internal Historical Track Record score Sᵢ 348. As before, weighting the individual sub-scores that make up the total SCF Internal Historical Track Record score Sᵢ 348 provides a method of prioritizing sub-scores and determining a relative value of that sub-score's contribution to the total SCF Internal Historical Track Record score Sᵢ 348. In one example implementation of the invention, criteria for weighting is selected by analyzing statistics and identifying characteristics of each sub-score's correlation to the total SCF Internal Historical Track Record score Sᵢ 348. The weight for each sub-score is assigned in the range from 1 to 5. The most important sub-score (i.e., that sub-score or sub-scores that have the strongest correlation to the total SCF Internal Historical Track Record score Sᵢ 348 and make the largest contribution to the SCF Internal Historical Track Record score Sᵢ 348) is weighted 5, and less important scores (i.e., that sub-score or sub-scores that have the weakest correlation to the total SCF Internal Historical Track Record score Sᵢ 348 and makes the smallest contribution to the SCF Internal Historical Track Record score Sᵢ 348) is weighted 1. The weights can be statically applied to each of the sub-scores, or can be dynamically determined and applied based on received fast data.

As mentioned briefly above, for the dynamic credit limit determination, the Financial Analysis Score 342 and Dilution Prediction component based on machine learning 333 are optional and can be used when the supply chain finance provider has access via integration to the respective data sources. The same is true for the Success/Social Value Score 347.

Other elements (scores, sub-scores, and sub-sub-scores) can be reliably used in the systems and methods in accordance with the invention to produce reliable results. Components (sub-scores) can be calculated based on fast data from the different data sources. The better and richer the data sources, the better the results that are produced by the methods and systems of the invention.

### Examples of How Methods and Systems of the Invention Can Be Used Cash Planner

One example of how the dynamic credit limit determination can be used is when suppliers need a specific amount of money (e.g., for payroll, inventory, working capital, etc.), a cash planner feature enables a user to enter an amount of money needed and automatically identifies invoices for early payment that total closest amount to the amount of money entered by the supplier (up to the amount of the dynamic credit limit). This provides a powerful cash management tool.

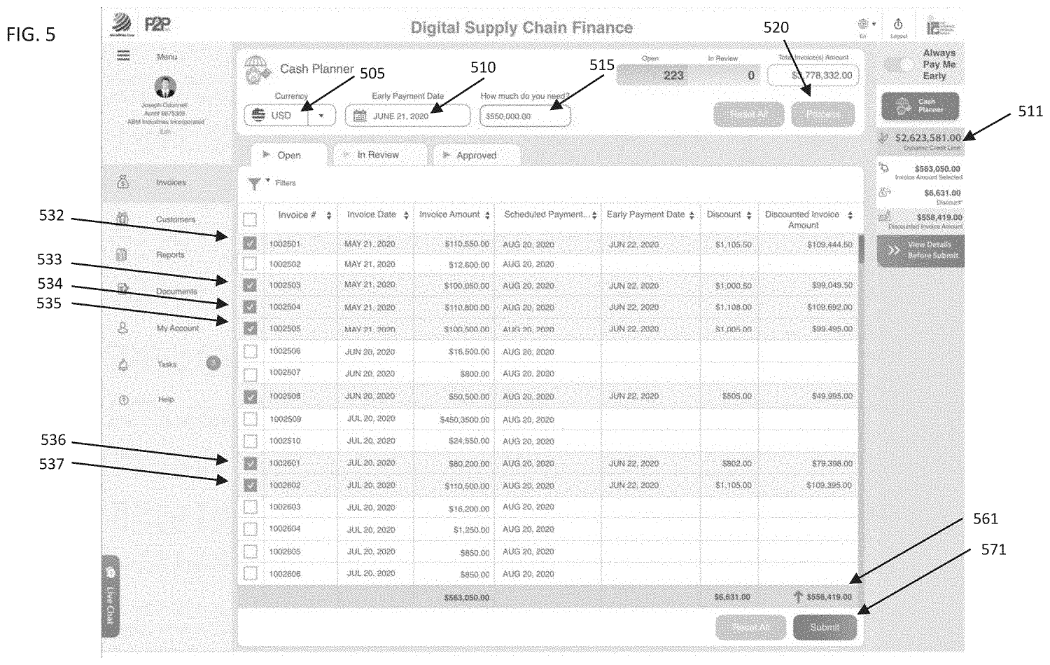

As shown in FIG. 5, from the invoice page of the supply chain finance supplier portal, the supplier selects the cash planner button and selects the currency of invoices 505 that the user wishes to review and enters an early payment date 510. The supplier enters an amount of money needed in the “How much do you need?” box 515. The amount needed cannot be greater than the dynamic credit limit 511 (the amount of early payment funding for which the supplier is approved). The user submits the cash planner using the process button 520, and the invoices 532, 533, 534, 535, 536, 537 are automatically identified for early payment to get to the closest amount of money needed. That is, invoices are identified that total 561 (or are close to) the amount of money needed 515. The supplier can then review the invoices 532, 533, 534, 535, 536, 537 identified and can de-select any of the identified invoices and manually select others, if desired. Once the list of invoices is finalized, the supplier submits the list of invoices 571, and the request is processed. In this fashion, an automated solution for cash flow planning is provided.

### Always Pay Me Early

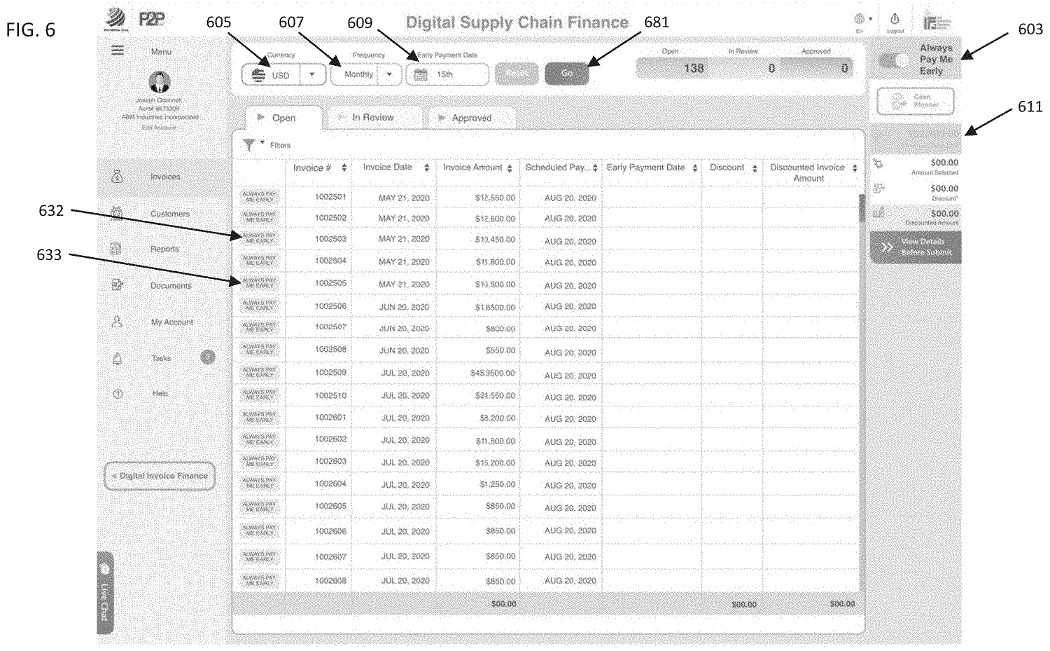

An additional example of how the dynamic credit limit determination can be used is when suppliers would like the digital supply chain finance method performed automatically (for example, without reviewing a list of invoices for early payment), the supplier can select an “always pay me early” feature shown in FIG. 6. This feature provides early payment of invoices approved and scheduled for payment by the buyer up to the amount of the dynamic credit limit 611.

As shown in FIG. 6, from the invoice page of the supply chain finance supplier portal, the supplier selects the always pay me early button 603 and selects the currency of issued invoices 605 which the user intends to select for funding. An “Always Pay Me Early” icon is displayed (e.g., reference numerals 632, 633) indicating the feature is selected. The supplier then enters a frequency of payment 607 (e.g., weekly, bi-weekly, monthly, quarterly). The supplier uses a calendar to choose a payment date 609 (e.g., monthly on the fifteenth of each month). The user submits 681 the always pay me early selections, and on the payment date, a notification and details (via email, for example) of the early payment transactions is provided. The “always pay me early” feature can be turned on and off at any time simply by using the button 603 on the interface screen (of FIG. 6). [000127] The systems and methods of the invention allow the supply chain finance providers to customize and add additional components (scores, sub-scores, sub-sub-scores) with identified weighting contributions and additional data sources that the supply chain finance provider finds valuable in determining the Dynamic Credit Limit calculations.

By using the systems and methods of the invention, supply chain finance providers can offer supply chain finance funding to Suppliers without requiring a Buyer's guaranty.

1. A digital supply chain finance system for creating a dynamic credit limit, the system comprising:
a dynamic credit limit server, including a processor and a memory storing computer-executable instructions that, when executed by the processor on the dynamic credit limit server cause the processor to perform acts comprising:
receiving a request for service from a supplier via a supplier portal to the dynamic credit limit server,
automatically receiving confirmed invoices from a buyer enterprise resource planning server,
automatically receiving fast data from a data source, wherein the received fast data includes digital compliance process measures, credit bureau measures, fraud indices, threat measures, Personal Property Securities Register (PPSR) entries, and UCC filing data, and
determining the dynamic credit limit for the particular buyer-seller pair at a particular moment in time based on
a gross amount of confirmed invoices issued to the buyer from the seller, the confirmed invoices including those invoices approved and scheduled for payment by the buyer and received from the buyer enterprise resource planning server,
a base ceiling, wherein the base ceiling includes an initial maximum percentage of the gross amount of confirmed invoices issued to the buyer from the seller that are available for funding;
a historic dilutions multiplier, wherein the historic dilutions multiplier is based on historical dilution events from the enterprise resource planning server of the buyer; and
a risk score multiplier.

2. A digital supply chain finance system of claim 1, wherein the dynamic credit limit server is one or more virtual servers running in a cloud computing environment accessed by the supply chain finance system via a data exchange network.

3. A digital supply chain finance system of claim 1, wherein the fast data includes real-time data received from an event-driven server application of the data sources.

4. A digital supply chain finance system of claim 1, wherein the fast data is received from an event-driven server application of the data source via an application program interface (API) or a secure file transfer protocol (SFTP).

5. A digital supply chain finance system of claim 1, wherein the fast data includes actionable data received from at least one of the group of sensors, actuators, and machine-to-machine data exchange sources.

6. A digital supply chain finance system of claim 1, wherein the base ceiling includes an initial maximum percentage of the gross amount of confirmed invoices issued to the buyer available for funding by the supply chain finance provider.

7. A digital supply chain finance system of claim 6, wherein the base ceiling is established per buyer by underwriters of the supply chain finance provider.

8. A digital supply chain finance system of claim 1, wherein the historic dilutions multiplier is based on at least one of the set of historical dilution events from an enterprise resource planning server of the buyer and a dilution prediction for the buyer-supplier pair.

9. A digital supply chain finance system of claim 8, wherein the historical dilution events from the enterprise resource planning system of the buyer include automatic analysis of the data of historic payment amounts for confirmed invoices and corresponding gross amounts for the same confirmed invoices issued by the supplier for a predetermined time period.

10. A digital supply chain finance system of claim 8, wherein the dilution prediction for the buyer-supplier pair is based on a machine learning (ML) model trained by billings and correspondent payments from 1st tier buyers to their suppliers in at least one of the group of different industries, different jurisdictions, and different economic cycles.

11. A digital supply chain finance system of claim 1, wherein the risk score multiplier is based on at least one of the set of
a financial analysis score, based on at least one of the financial analysis set of a profit and loss statement, a balance sheet, an accounts receivable aging report, and an accounts payable aging report, wherein the financial analysis set is automatically received from accounting software of the supplier;
a fraud-threat score, wherein the fraud-threat score is based on at least one of the fraud-threat set of an email risk based on an email address age, an IP address confidence based on a historical IP address fraudulent use, an IP address risk based on a location of an IP address and a supplier location, a Proxy-VPN-TOR determination based on a direct or non-direct connection, an email free-corporate determination based on whether a user is using corporate email or free email, a city confidence score based on a location of a city and proximity to the supplier's address, a geolocation score based on a supplier's address and IP address, a location accuracy radius score based on a supplier business location and user IP address distance, a location average income score based on a weighted average income per person for a postal code associated with the IP address, a postal confidence score based on a business account address or a credit card address and a user address, and an address-phone residential-business score based on a user connection location), and wherein the fraud-threat set is automatically received by the dynamic credit limit server, and wherein the fraud-threat score is automatically determined immediately prior to the moment in time when the dynamic credit limit for the particular buyer-seller pair is determined.
a compliance score, wherein the compliance score is based on at least one of the compliance set of an international watchlist score based on an Office of Foreign Assets Control sanctions list, an enhanced credit score based on a combination of data from one or more registered credit agencies and augmented with at least one of the set of utility records, electoral rolls, and drivers' license records, a passport-driver license-ID validation score, an address validation score, and a utility score based on correlation of utility bills with a user address;
and wherein the compliance set is automatically received by the dynamic credit limit server, and wherein the compliance score is automatically determined immediately prior to the moment in time when the dynamic credit limit for the particular buyer-seller pair is determined;
a business credit score, wherein the business credit score is based on at least one of the business credit set of an active registration-time in business score, a derogatoriness score, an insolvency history score, a collection-revenue ratio score, a tax liens-CCJ history score, and a trade names score, wherein each of the at least one of the set of scores is based on credit reports in data-feed format automatically pulled from a credit bureau;
a filed liens score, wherein the filed liens score is based on at least one of the filed liens set of a number of not-terminated filings (UCC/PPSR/Charges) score, a number of not-terminated filings (AR/Debtors) score, a not-terminated filings (Inventory) score, a not-terminated filings (PMSI) score, a not-terminated filings (All Assets) score, all based on collateral descriptions, and an alternate payee score based on existence of an active payment assignment to a third party, and wherein the filed liens set is automatically received by the dynamic credit limit server, and wherein the filed liens score is automatically determined immediately prior to the moment in time when the dynamic credit limit for the particular buyer-seller pair is determined;
a success-social value score, wherein the success-social value is based on at least one of the success-social value set of a level of education score, a career score, a loyalty score based on frequency and duration of job changes , a Social Activity score based on at least one of the set of user social involvement in charities, community activities, and military background., and a reputation score based on collected data related to user-signer reputation, and wherein the success-social value set is automatically received by the dynamic credit limit server, and wherein the success-social value score is automatically determined immediately prior to the moment in time when the dynamic credit limit for the particular buyer-seller pair is determined; and
a track record score, wherein the track record score is with the supply chain finance provider and is based on at least one of the track record set of a longevity of account score, a defaults number to transactions number ratio, a ratio of post-confirmation dilution to gross amount of all confirmed invoices, a ratio of post-confirmation dilution to a total of an amount of automatic recourse available in the current payment period and an amount of automatic recourse available in the next payment period, and a total confirmed invoices score, and wherein the track record set is automatically received by the dynamic credit limit server, and wherein the track record score is automatically determined immediately prior to the moment in time when the dynamic credit limit for the particular buyer-seller pair is determined.

12. A digital supply chain finance system of claim 11, wherein each of the scores from which the risk score multiplier is based, is statically or dynamically weighted based on the received fast data.

13. A digital supply chain finance system of claim 12, wherein a different static or dynamic weight multiplier applies to each score to differentiate contributions of each score to the risk score multiplier.

14. A digital supply chain finance system of claim 11, wherein the financial analysis score is also based on at least one of the set of an extrapolated income determination, an equity-income ratio, an assets-liability ratio, a monthly revenue ratio, a total accounts payable-accounts receivable comparison, and a time-based accounts payable-accounts receivable comparison, a highest accounts receivable concentration, and a reporting period.

15. A digital supply chain finance system of claim 11, wherein the risk score multiplier is also based on at least one of the set of an Authentication Result score, an ID Passed/Failed/Unknown score, a Total ID Verification score, an ID Barcode Verification score, and an ID Data Extraction Reliability Level score.

16. A digital supply chain finance system of claim 15, wherein the least one of the set of the Authentication Result score, the ID Passed/Failed/Unknown score, the Total ID Verification score, the ID Barcode Verification score, and the ID Data Extraction Reliability Level score is based on analysis of driver licenses or passports for a predetermined jurisdiction.

17. A digital supply chain finance system of claim 11, wherein the post-confirmation dilution includes at least one of the set of an amount of unrelated credit-memos applied on the same date as an invoice scheduled payment date, an amount of chargebacks, withholdings, counterclaims and an amount of set-offs.

18. A digital supply chain finance system of claim 11, wherein the loyalty score includes a level of continued effort to achieve a goal and a measure of jumping from project to project.
